(19) United States
(12) Patent Application Publication
(10) Pub. No.: US 2024/0167727 A1
(43) Pub. Date: May 23, 2024

(54) Tankless Hot Water Heater

(71) Applicant: It's Optimal, LLC, Coral Gables, FL (US)

(72) Inventors: Nicholas Cardoso, Key Briscayne, FL (US); Ryan Ramirez, Miami Lakes, FL (US); Robert Baranowski, Valley Center, CA (US)

(73) Assignee: It's Optimal, LLC, Coral Gables, FL (US)

(21) Appl. No.: 18/483,574

(22) Filed: Oct. 10, 2023

Related U.S. Application Data
(60) Provisional application No. 63/384,543, filed on Nov. 21, 2022.

(51) Int. Cl. F24H 15/174; F24H 1/10; F24H 15/215; F24H 15/238

(52) U.S. Cl. CPC F24H 15/174; F24H 1/102; F24H 15/215; F24H 15/238; G01F 1/667

(57) ABSTRACT

The invention relates to a water heater comprising a cold water inlet, a hot water outlet, a fluid pathway arranged between the cold water inlet and the hot water outlet, one or more heating elements that heat water in the fluid pathway, a power electronics unit coupled to the one or more heating elements, a controller configured to regulate a temperature of the water in the fluid pathway to an adjustable hot water temperature by controlling the power electronics unit, a flow sensor to detect a water flow through the fluid pathway, and an inlet water temperature sensor adapted to determine an inlet temperature of the water. The controller determines the power that is less than the maximum power that needs to be applied to the one or more heating elements and control the power electronics unit to modulate the power applied to the one or more heating elements so that the power is equally distributed across the one or more heating elements and whereby during any fixed period of time each of the heating elements is turned on for an equal amount of time.

### TECHNICAL FIELD OF THE INVENTION

The technical field of the invention relates to tankless hot water heaters that modulate power to the heating elements to ensure longevity of the circuitry and optionally include ultrasonic flow meters to accurately measure water flow.

### BACKGROUND OF THE INVENTION

Households and many businesses require hot water for everyday use. Most hot water consumers typically rely on conventional storage water heaters to store and constantly heat water for production upon demand. A variety of fuel options are available for conventional storage water heaters, including electricity, natural gas, oil, and propane. Typically ranging in size from 20 to 80 gallons (75.7 to 302.8 liters), storage water heaters remain the most popular type for residential heating needs in the United States. A storage heater operates by releasing hot water from the top of the tank when the hot water tap is turned on. To replace the hot water released, cold water enters the bottom of the tank, ensuring that the tank is always full.

Because the water is constantly heated in the tank, energy can be wasted even when no faucet is on. This is called standby heat loss. It is possible to completely eliminate standby heat loss from the tank and reduce energy consumption by 20% to 30% with demand (tankless) water heaters, which do not have storage tanks. Cold water travels through a pipe into the unit, and either a gas burner or an electric element heats the water in the pipe only when needed.

Tankless water heaters save energy because they do not need to constantly heat water in a large storage tank. To achieve this, tankless water heaters instantaneously heat water as it passes from the consumer's water supply to the outlet (e.g. faucet or showerhead). The tankless water heater, therefore, needs to “know” when hot water is in demand in order to function properly. Flow switches are used to signal the tankless water heater that the consumer desires hot water. Briefly, when a consumer turns on a faucet, dishwasher, or any hot-water-requiring device, water flows from the water supply through the tankless water heater system. This flow of water causes the flow switch to activate the heating element (e.g. gas or electric) of the tankless water heater. Conventionally, a tankless water heater uses a rotometer to measure flow through the piping in the heater. Such rotometers can be paddle- or bullet-based.

Electric tankless water heaters apply electric power to heating elements to elevate the temperature of the heating elements. Because the heating elements are immersed in water, the heat is transferred from the heating elements to the water to elevate the water temperature. Generally, an electric tankless water heater would have multiple heating elements. A controller would turn on one heating element at a power level needed to attain the desired output water temperature.

For example, referring to FIG. 1, a conventional tankless hot water heater 10 may have four electrically powered heating elements 15, 20, 25, 30. The heater 10 includes an outer case 5, multiple heating pipes 35, and a controller 40 with a display and an internal processor. The controller receives input from an outlet thermistor or sensor 45, an inlet thermistor or sensor 50, and a flow meter or sensor 55. The piping system. or fluid pathway, includes a fluid inlet (or cold water inlet) 60 and a fluid outlet (or hot water outlet) 65 and the water flow pathway between the fluid inlet and fluid outlet. Cold water flows into the fluid inlet 60 and past the flow meter 55 and inlet thermistor 50, which transmit signals to the controller 40. The water flows past first heating element 30, second heating element 25, third heating element 20 and fourth heating element 15, which heat the water flowing past. The heated water then flows past the outlet thermistor 45, which transmits a signal to the controller 40. The heated water exits the heater 10 through outlet 65. Based on an algorithm coded in the internal processor of the controller, the heating elements are powered to heat the water as a function of the input from the thermistors 45, 50 and flow meter 55.

Generally, the heating elements are powered sequentially with the first heating element fully powered before the second heating element is powered, and so forth. For example, if a user desires to run a dishwasher, the first heating element 30 could be powered at 50% of its power capacity to achieve a first desired temperature. If the user then desires to wash a load of clothes with hot water at the same time, the flow rate through the heater 10 increases and the power supplied to the first element 30 could be increased to 100% and the second heating element 25 powered to 50% of its power capacity. If someone at the same location then decides to take a shower, further increasing the water being heated by the heater 10, the second heating element 25 may be powered at 100% of its power capacity, the third heating element 20 turned on at 100% of its power capacity and the fourth heating element 15 turned on at 35% of its power capacity. As should be evident, the number of heating elements powered and the degree to which they are powered will be a factor of the water flow through the heater, the desired temperature of the water output from the heater, and the input temperature of the water supplied to the heater.

The inventors have recognized that an arrangement of powering the heating elements of the heater 10 of FIG. 1 will result in more wear on the first element than the second element, and more wear on the second element than the third element, etc. Further, to the extent there is circuitry associated with each element, that circuitry will similarly be subjected to wear in the same manner as its associated heating element. The inventors have developed methods and equipment to address these problems.

### BRIEF DESCRIPTION OF THE DRAWINGS

FIG. 1 is a plan view of a tankless, on-demand hot water heater.

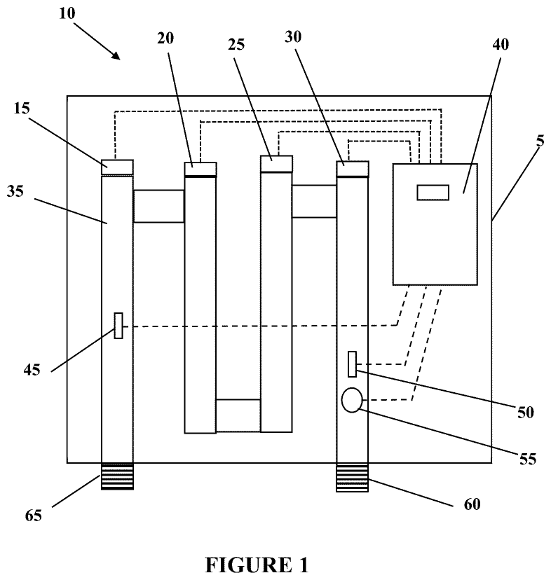

FIGS. 2-5 are perspective, left side, front and right side views of one embodiment of a tankless, on-demand hot water heater of the invention.

FIGS. 6 and 7 are front and perspective views of one embodiment of a tankless, on-demand hot water heater of the invention having a single heating element.

FIGS. 8-10 are top, front and bottom views of the internal piping of a single heating element unit.

FIGS. 11-13 are top, front and bottom views of the internal piping of a double heating element unit.

FIGS. 14-16 are top, front and bottom views of the internal piping of a triple heating element unit.

FIGS. 17-19 are top, front and bottom views of the internal piping of a four heating element unit.

FIGS. 20 and 21 are perspective view of the internal piping of single and double heating element units showing the assembly of ultrasonic transducers used on the inlet piping.

FIGS. 22-24 illustrate different configurations of the ultrasonic flow transducers and tubing.

FIGS. 25 and 26 illustrate the circuitry that controls individual heating elements.

FIG. 27 illustrates one embodiment of pulse shifting used to power a heating element.

FIGS. 28 and 29 are related flow charts illustrating how the controller powers the heating elements and calibrates the system to correct for discrepancies in the power applied to the heating elements and the resulting heating of the water.

### DETAILED DESCRIPTION OF THE INVENTION

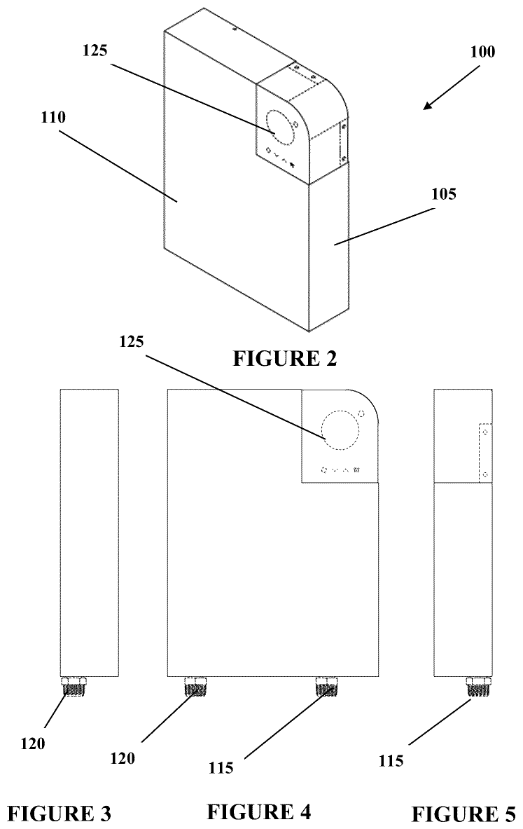

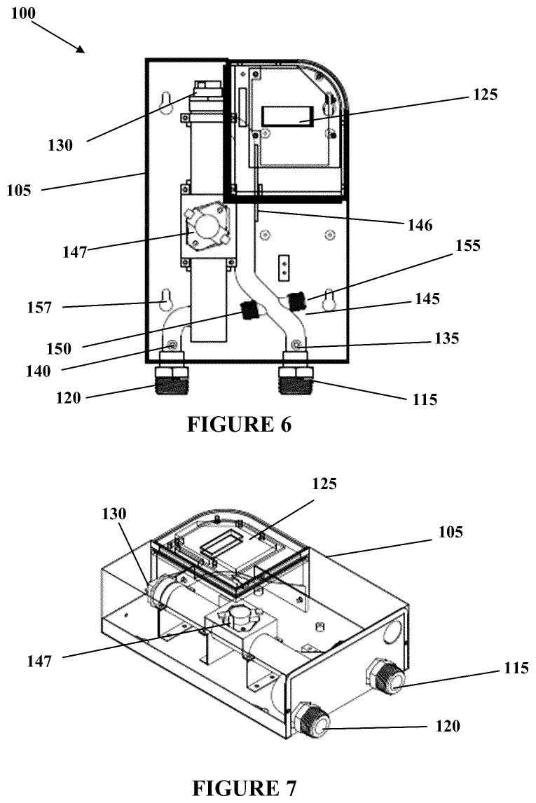

Referring to FIGS. 2-7, a tankless hot water heater 100 includes an outer case 105, a front panel 110, an inlet connection 115 and an outlet connection 120 and a fluid pathway between the inlet and outlet connections to convey water flowing from the cold water inlet to the hot water outlet. The inlet connection 115 serves as a cold water inlet and the outlet connection 120 serves as a hot water outlet. The front panel includes a display 125 with one or more user-activated buttons to adjust and set the desired water temperature. The display may be a LED or LCD display, or a display based on other technology. Referring specifically to FIGS. 6 and 7, the heater 100 includes piping of the fluid pathway with a single heating element 130, an inlet thermistor sensor 135, an outlet thermistor or sensor 140, and an ultrasonic flow transducer system 145 that includes a pair of transducers or sensors 150, 155. The inlet thermistor 135 measures the temperature of the water entering the heater 100 prior to being heated by the heating element 130. The outlet thermistor 140 measures the temperature of the water exiting the heater 100 after being heated by the heating element 130. A controller with a CPU is positioned within the case 105 in proximity to the display 125. The outer case 105 can include one or more mounting openings 157 in the back for convenient mounting to a surface.

The heater 100 is provided with a plate 146 mounted to the tubing through which the water flows. As evident from FIG. 6, the plate 146 is mounted to the tubing upstream from the heating elements such that the water has not been heated prior to passing by the plate. Triacs, described below, are mounted to the plate 146. The plate 146 is used as a heat sink for cooling triacs that are used to supply power to the heating elements. Because of current flow through the triacs, they heat up during use. Because of cold water flow through the tubing, the plate will be cooled during use. To promote the longevity of the triacs they are mounted to the plate so that the heat generated during their use is transferred to the cold plate. Each heating element would have an associated triac. The triacs and associated electronics are optionally referred to herein as the power electronics unit.

The heater 100 is provided with a safety thermistor 147 mounted to the tubing downstream from the heating element 130. The safety thermistor 147 is designed to shut down power to its associated heating element if the temperature measured is greater than a set value, e.g., 125° F., that could scald a person. If the heater 100 has multiple heating elements, each would have its own safety thermistor 147.

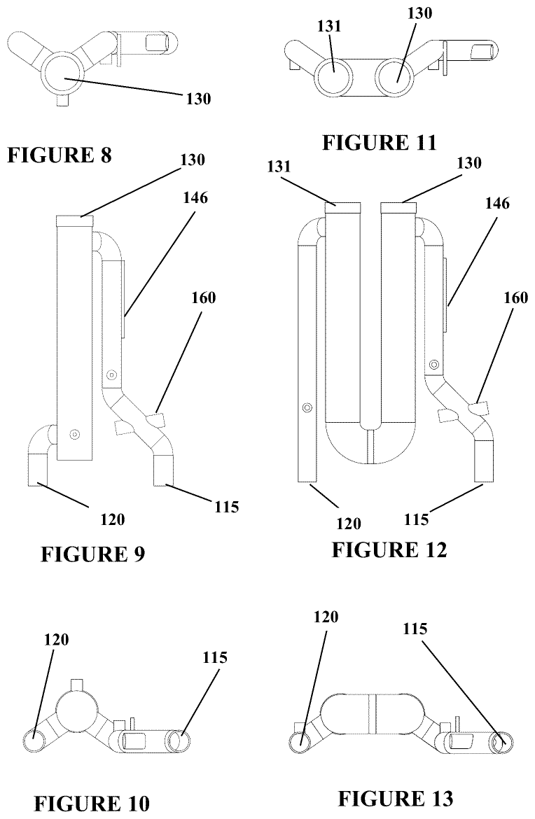

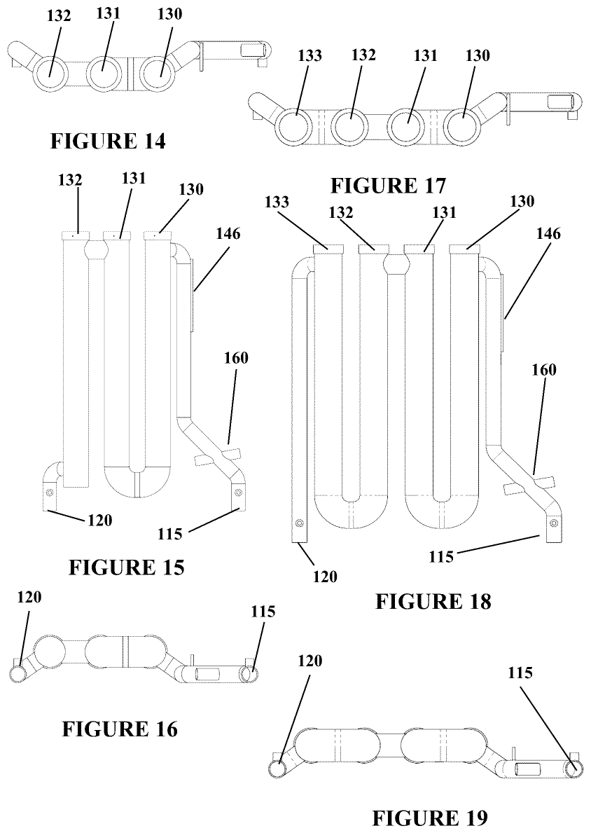

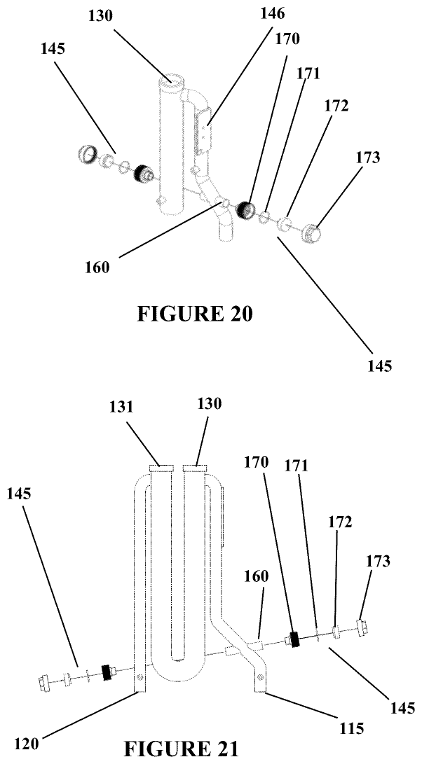

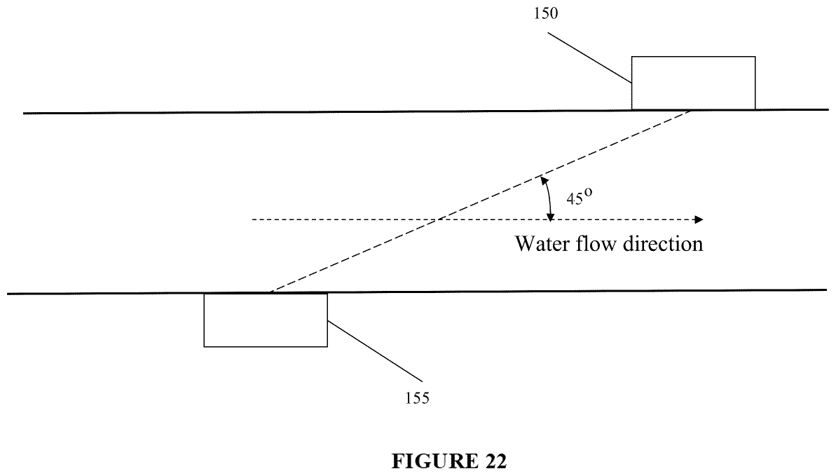

FIGS. 8-19 illustrate the piping system within a single heating element system (FIGS. 8-10), a double heating element system (FIGS. 11-13), a triple heating element system (FIGS. 14-16) and a four heating element system (FIGS. 17-19). The single heating element system includes an opening for the first heating element 130, transducer mounting openings 160, heat sink plate 146, and the inlet 115 and outlet 120. The double heating element system includes an opening for the first heating element 130, an opening for the second heating element 131, transducer mounting openings 160, heat sink plate 146, and the inlet 115 and outlet 120. The third heating element system includes an opening for the first heating element 130, an opening for the second heating element 131, an opening for the third heating element 132, transducer mounting openings 160, heat sink plate 146, and the inlet 115 and outlet 120. The four heating element system includes an opening for the first heating element 130, an opening for the second heating element 131, an opening for the third heating element 132, an opening for the fourth heating element 133, transducer mounting openings 160, heat sink plate 146, and the inlet 115 and outlet 120. It should be understood that the number of heating elements is not limited to those disclosed herein. Further, the arrangement of the piping and heating elements illustrated in the figures can be modified as desired and is within the ability of one of skill in the art.

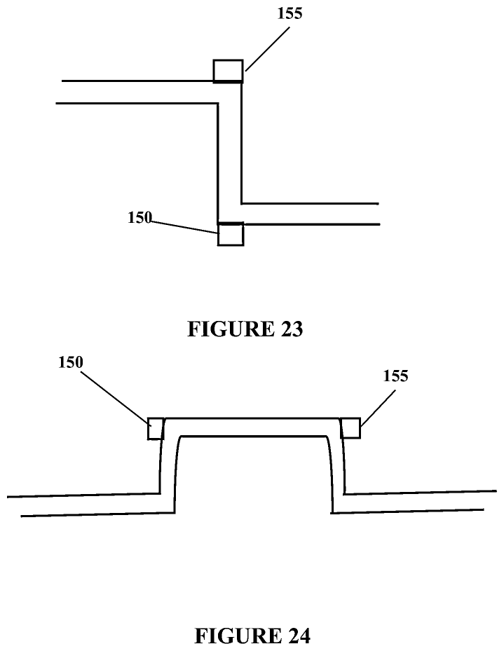

FIGS. 20 and 21 illustrate the components of the ultrasonic transducer system 145. The system 145 is arranged with a flow sensor mount 170 positioned within or around the transducer opening 160. An O-ring 171 is positioned within the flow sensor mount 170, followed by an ultrasonic transducer 172. The transducer 172 is held in place by a transducer cap 173. The ultrasonic transducer system includes a pair of openings 160 with each opening including oppositely oriented transducers with the same components positioned in or around each opening.

The components of the transducer system 145 are selected to acoustically isolate the ultrasonic transducers 172 from the piping while being in contact with the water. The design objective is to configure the ultrasonic transducers to send and receive the sound waves through the water but avoid causing the sound waves from passing through the pipe. This is achieved by the acoustic isolation of the transducer. In a preferred embodiment, the flow sensor mount 170 is made of the same material as the piping and opening 160. The O-ring 171 is made of a different material from the mount and pipe. In a preferred embodiment the O-ring is made of rubber or plastic. The transducer cap 173 and flow sensor mount 170 are made of different materials with the cap being made of, for example, rubber or plastic. With this configuration of the mount, O-ring and cap, the transducer is acoustically isolated from the piping.

Alternatively, the ultrasonic transducers could be mounted to the outside of the pipe without being in contact with the water. Typically mounting transducers outside of the pipe would require much higher ultrasonic power and more expensive circuitry, but has the advantage of a less complicated assembly. Also, turbulence induced by the tangential pipes for the transducer mounting is eliminated with installing the transducers outside the pipe.

In use, the ultrasonic transducer emits sound waves that pass through the water in the pipe and are received by the opposite ultrasonic transducer. The opposite transducer emits sound waves to the first transducer and the difference in time between the two is proportional to the flow of fluid through the pipe.

Advantageously for this application, the sound waves pass much better through water than through air. With such properties, the ultrasonic transducer can be used to detect air bubbles in the piping. Thus the ultrasonic transducer system can be used to measure both water flow rate and detect air bubbles. Methods can be applied to determine if there are just a few small bubbles in the flow all the way to the flow being basically air moving through the pipes. The reason to measure air bubbles in the piping is to prevent failure of the heating elements. If the heating elements are heating air rather than water, the elements are likely to overheat and fail. Although the use of ultrasonic transducers is a preferred embodiment, the inventors intend that other methods can be used to detect air and are included in the invention as options if the ultrasonic transducer system is not set up to detect air bubbles.

An advantage of the ultrasonic transducer arrangement of the invention is that the transducers are in contact with the water. If the transducers are not directly in contact with the water but instead are in contact with the metal pipes such that the sound waves must go through the metal, additional electronics would be needed to amplify the signal. The preferred embodiment of the transducer system advantageously avoids the need for such complicated electronics. Nonetheless, in one embodiment of the invention, the ultrasonic transducers are not in contact with the water and the system includes the electronics needed to amplify the signal. Such a transducer system would be easy remove and replace but would require the additional electronics.

Another advantage of the transducer arrangement of the invention is the ability to easily remove and replace the ultrasonic transducers if needed. Typical transducers are configured as part of a molded unit with the fluid flow pipe, the side pipes extending from the fluid flow pipe and the transducer mounted in the side pipes. The molded unit is removed and replaced in its entirety, which is not an insignificant undertaking. This aspect of the invention permits unscrewing or removal of the transducer cap, removing the transducer and then the reverse of the same steps, a much easier and quicker process.

Another advantage of the ultrasonic flow transducer is the expectation of greater reliability than currently used paddle or bullet flow meters, which are mechanical devices with moving parts. Because the transducer system does not have any moving parts it will avoid that mode of failure. If the heater includes a mechanical flow meter to measure water flow through the heater, flow meter failure could result in an inaccurate flow measurement. If piping in the heater has a large air bubble around the heating elements, paddle or bullet flow meters will still turn as the air passes, failing to recognize the air-inclusion condition, the heating elements can burn out. The inventors have recognized that there would be a benefit to a flow measurement system that does not include any moving parts to eliminate that mode of failure of the flow measurement system.

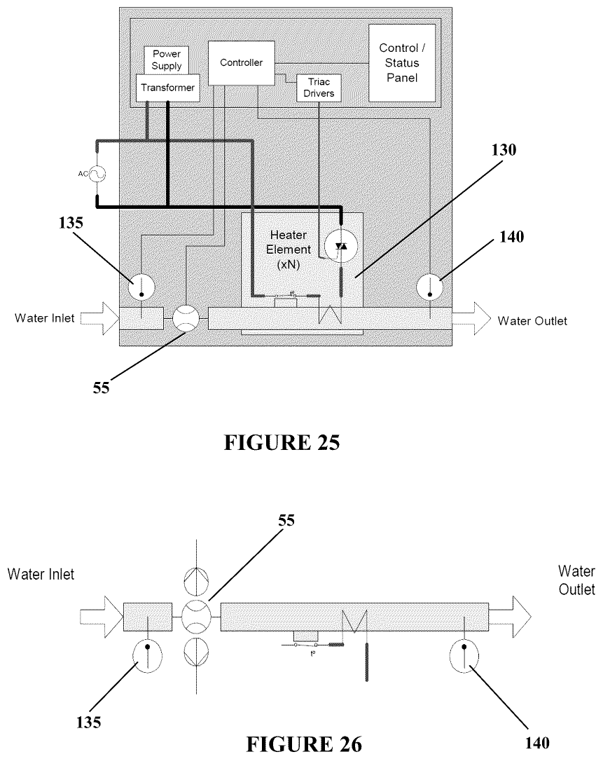

The ultrasonic flow transducer functions best when the angle between the transducers and the flow of water is close to 0 degrees and functions poorly when the angle is 90 degrees. The function improves as the angle is reduced from 90 degrees towards 0 degrees. Referring to FIG. 22, the flow transducers 150, 155 can be mounted at an angle of 45 degrees in an embodiment where the pipe is generally straight and the transducers 150, 155 are offset from each so that there would be a 45 degree angle between them. FIGS. 23 and 24 illustrate two examples of a piping configuration where the angle between the flow transducers 150, 155 and the flow of water is 0 degrees. It should be understood that the piping arrangements illustrated in FIGS. 8-21 can be modified to include a segment of the inlet that include a piping configuration according to any of FIGS. 22-24, or a variation of one of these designs. It should be understood that the ultrasonic flow transducers described herein can be mounted within the pipe (i.e., in the water) or outside the pipe.

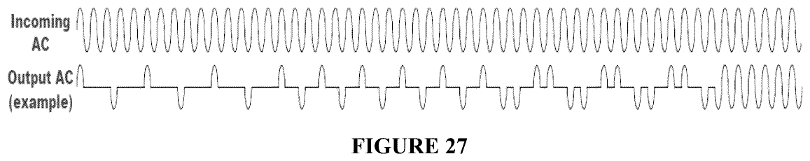

FIGS. 25 and 26 illustrate the electrical connections and the signals between the transducer, heater element, triac, triac drivers, controller, power supply, transformer and control/status panel. The inlet thermistor 135, the second thermistor 140, and a flow meter 55 provide electrical signals to the controller, which uses the data provided to operate the triac drivers that use the triacs to power the heating element 130. It should be understood that additional triac drivers, triacs and heating elements would be provided for a heater with multiple heating elements, such as those discussed herein.

Another aspect of the invention involves a novel method of powering or modulating the power to the heating elements to heat the water to ensure longevity and reliability of the heating elements and associated electronics. Conventional tankless hot water heaters with multiple heating elements power a first element 100% prior to powering a second element, which would be powered to 100% prior to power a subsequent element and so forth for additional heating elements. As can be recognized, the first heating element and associated electronics will have more use and wear than the second heating element and associated electronics.

The controller is configured to determine the power that is less than the maximum power that needs to be applied to the one or more heating elements and control the power electronics unit to modulate the power applied to the one or more heating elements so that the power is equally distributed across the one or more heating elements. In this manner, during any fixed period of time each of the heating elements is turned on for an equal amount of time. Modulation is understood herein to mean the process of applying power and varying the amount of power applied to a heating element when the power is between a value of zero and the maximum value of power available from the AC line source.

The method of powering the heating elements according to one aspect of the invention ensures longevity and reliability by using one or any combination of three techniques. First, the controller turns on and off each heating element only on the AC half cycle where the voltage is 0. In a related embodiment, the controller turns on and off each heating element at a portion of the half cycle, e.g., at turning on one at 20 percent of the half cycle. Second, the controller turns the heating elements on in a random manner so that no heating element will have significantly more use and wear than the other heating elements. In a related embodiment, the controller accomplishes the same outcome by turning heating elements on in a programmed sequence so that no heating element will have more use and wear than the other heating elements. Third, the controller turns the heating elements on to the same power level.

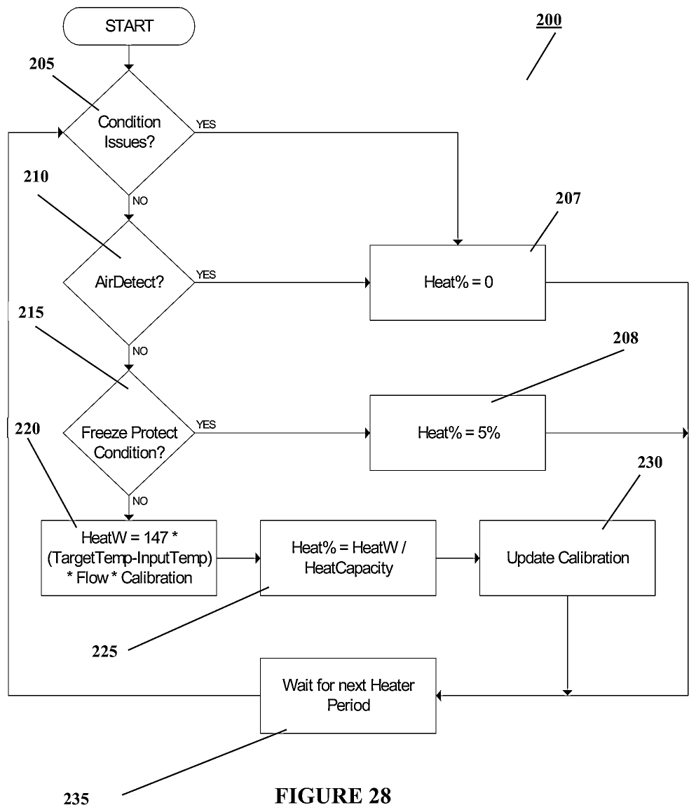

FIG. 27 illustrates the power supplied to, and supplied by, one heating element. As can be seen from the output AC graph, which reports the output for one heating element, the heating element is powered on when the power is at 0 volts and then turned off when the power again is at 0 volts. This reduces the wear of the triac and triac drivers associated with the heating element if it was powered on when the voltage was at a higher level, which results in power spikes that generate electromagnetic interference (EMI). If the controller is programmed to turn on and off at the half cycle where it is at zero (crossing the axis) these is a reduced current spike because if the voltage is zero (v=0) then the current is zero (i=0). As voltage increases, current increases. By avoiding turning on and off when voltage is zero, the circuitry components (i.e., the triacs) are protected from current spikes. This timing of providing power to the heating element also reduces the EMI associated with the turning on and off the power. Reducing EMI will reduce, for example, interference with wireless devices in the house or building with the heater operating. This method of turning on the heating elements contrasts with conventional heaters that use phase modulation where the heating elements are turned on at different points in the AC cycle rather than always turning on when the voltage is zero.

The system also avoids turning on all heating elements at the same time. If the heating elements are all turned on at the same time, the result is likely to be light flicker and other noticeable power disruptions in the house or building. Although all heating elements can be on at the same time, such as during maximum heating applied, the system is designed to minimize turning on multiple elements at the same time.

As evident from FIG. 27, the duty cycle of the heating element is being varied from left to right on the figure. If a heating element or combination of heating elements is turned on for only one half cycle of every 100 half cycles, the duty cycle is on at 1%. Similarly, if a heating element or combination of heating elements is on for ten half cycles of every 100 half cycles, the duty cycle is on at 10%. If a heating element or combination of heating elements is on for 50 half cycles of every 100 half cycles, the duty cycle is on at 50%. It should be understood that when the heater has multiple heating elements the duty cycle would be spread around the multiple heating elements. As one aspect of the invention, for a four heating element heater, the duty cycle could be distributed according to an algorithm for either random distribution or a preset distribution.

For distribution according to random distribution, the duty cycle (and therefore the power) could be distributed according to elements 1, 2, 3, 4 and then 2, 4, 1, 3 and then 4, 3, 1, 2, etc. For distribution according to a preset distribution, the duty cycle could be distributed according to elements 1, 2, 3, 4 and then repeated in the same distribution. In either distribution, this sequential distribution of power would be evenly distributed between the heating elements and thereby avoid uneven wear of the heating elements and associated circuitry, and also minimize multiple heating elements being on at the same time.

As should be evident from the above explanation, the heater according to one aspect of the invention does not necessarily have all of the heating elements on at the same time when considering the time scale of the AC cycle. For a heater with four heater elements the first unit would be powered on at a half cycle of the AC cycle and then turned off. The second unit would then be powered on at a subsequent half cycle of the AC cycle and then turned off. The third and fourth heating elements would likewise be powered on and off. FIG. 27 shows the AC cycle and then the turning on and off of the individual heating elements on the half cycles.

In one aspect of the invention the power output, or duty cycle, is controlled by a look-up table programmed in the controller. The look-up table uses the measured input water temperature, the desired output temperature and the measured flow rate to set the power output to the heating elements. In another aspect, the power output is controlled by an algorithm that uses the input water temperature, desired output temperature and measured flow rate to calculate the power output necessary. The system also measures the output water temperature and uses that value to determine the accuracy of the power calculation and whether a calibration of the power supplied to the heating elements, or an individual heating element, is necessary.

The heating elements would be each turned on to the same degree, e.g., 10%, 25% power level as needed. Advantageously, in this manner each heating element is used to the same degree so each, and its associated circuitry, should wear equally. This provides a more reliable unit than the prior art that operates one heater element more than others. The heater element and its associated circuitry would wear out faster if that element is used more than other elements. The inventors have determined that the invention can use a modification of the prior art method by have a random first heater turning on and then randomly adding a second heater element for modulation and so on. In this manner, the heater elements should wear out at an equal rate.

Turning the elements on at the half cycle advantageously reduces EMI. When the unit is turned on at the half cycle at 0 volts then the current would be at 0 amps (i.e., v=ir), since the heating elements are resistors. As the voltage increases so would the current. In this manner the heater element and associated circuitry (i.e., triac) would not be subjected to the surges in current and voltage, which reduces the wear on the triac.

Turning the heaters on and off in a distributed manner also reduces light flicker. It is known that if the heaters were turned on and then off after more cycles, such as ten cycles, the low frequency switching would be expected to generate flicker. In contrast, turning the heater on and off after single cycles would reduce flicker.

Another aspect of the invention is the use of a separate circuit (i.e., triac and triac driver) for each heater. Therefore each heater and its associated circuitry would be running at a proportion of the full load.

Another aspect of the invention is the inclusion of diagnostic capabilities. For example, the system may be programmed to provide indications as to whether one of the thermistors is connected or shorted, air inclusion diagnostics, and flow rate diagnostics and error. The system is programmed to look at the discrepancy between heat applied to achieve a temperature and the temperature measured. The system would be programmed to determine if the temperature achieved is different from that expected. If the temperature measured is different from what expected, the system is programmed to calibrate the system to correct the amount of power supplied. However, if the calibration factors calculated show a tendency to becoming too large or small, the system is programmed to know that something is incorrect more than can be corrected by calibration factors and provide an error code. For example, if the calibration requires calibration factors that go past ±20% on the calibration then the system would be programmed to note the error. Of course, the 20 percent value can be changed if needed and increased or decreased as desired.

Another diagnostic capability would be the ability to determine the presence of air in the line. Air in the line can cause damage to the heaters, as described above. With this diagnostic capability the system is programmed so that it will not turn the heaters on if no water is at the sensors. For example, the system will not turn on the heaters until there is sufficient water flow without air bubbles. Prior art flow sensors use a paddle wheel to measure flow, but air would turn the wheel and therefore the system would not recognize that it is air and not water in the system. For the ultrasonic transducer, the sound waves pass through water better than through air and would not be received on the other side at the same amplitude. The ultrasonic transducers can be used to determine the presence of air bubbles in the line. As explained above, the ultrasonic sensors send a pulse in one direction and see how long it took to get there and then the opposite direction from the opposite sensor. Flow rate is diagnosed, i.e., measured, by the difference between the two.

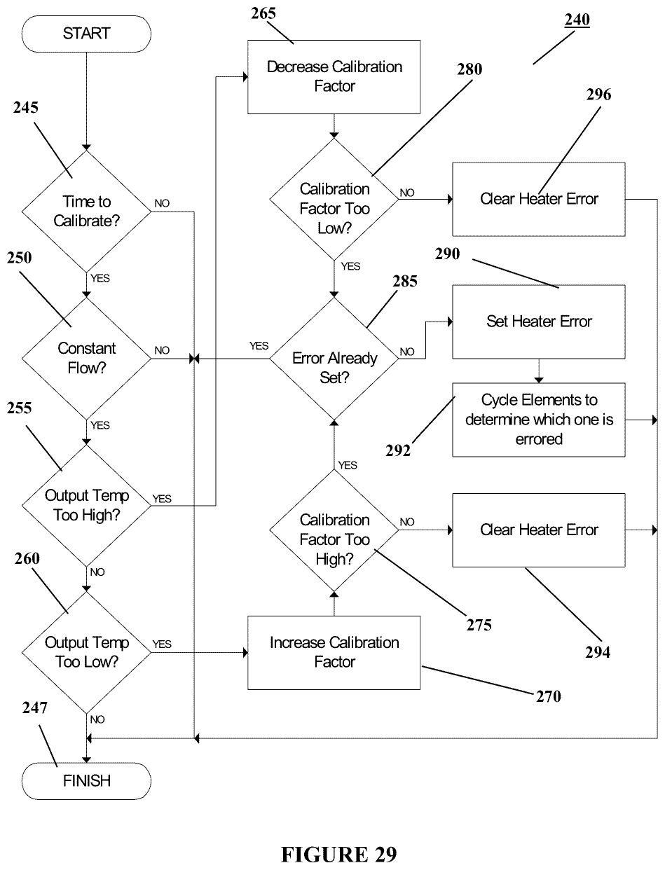

FIGS. 28 and 29 illustrate the heating and calibration methods, respectively, used by the system. According to an algorithm for a method 200 of controlling the heat applied to the water, the user sets a desired temperature for the water output from the heater and then starts water flow by turning on a tap or starting an appliance that uses heated water. In step 205, the controller is programmed to perform a number of condition checks. For example the controller may be programmed to (1) take input from the flow transducer to see if there is reverse flow, (2) determine if the desired temperature set by the user is outside the range that the heater can provide, (3) compare the temperature of the water measured at the inlet thermistor 135 to the desired temperature set by the user to determine if the input water temperature is greater than the desired temperature, and (4) compare the temperature of the water measured at the outlet thermistor 140 to the desired temperature to determine if the outlet water temperature is greater than the desired temperature. If any of these conditions are met, (e.g., the inlet water temperature is greater than the desired temperature the controller sets the heater percentage at 0% (step 207) and the heating elements are not powered on. In contrast, if the inlet water temperature is less than the desired outlet/output temperature (i.e., the temperature measured at the inlet thermistor 135 is less than the desired temperature of the water set by the user) the controller is programmed to proceed to step 210, detection of air in the line, termed “AirDetect” in FIG. 28. Similarly, if a reverse flow event is detected, no heat is applied. Such an event can occur if the heater is initially installed with the water connections reversed, i.e., the outlet water connection is connected to the water supply line and the inlet water connection is connected to the water line to the house. Upon correcting the misconnection, the reverse flow condition will be “no.” The inventors have included this optional condition based on their knowledge that the connections are often reversed during installation. Another condition leading to a reverse flow condition is when water is drained from a residence, such as when winterizing the property. In winterizing the pipes the water would be drained and air blown through the pipes. Heating the water in such an event could damage the heating elements and system.

In step 210, the software in the controller is programmed to set the heater percent at 0% (step 207) if the ultrasonic flow sensor, or other air detection means, provides a signal indicative of the present of air or air bubbles in the line. If air or air bubbles are not measured to be present, the controller proceeds to step 215, a comparison of the temperature of the water measured at the inlet thermistor 135 to a temperature programmed to be indicative of a temperature that could cause water to freeze within the heater. Such a temperature can be, for example in the range of 33° F. to 43° F. with 40° F. being a suitable temperature. If the controller determines that the water temperature in the system (e.g., at the inlet or outlet thermistor), the controller is programmed to set the heat at 5% of its capacity (step 208). In this manner the water in the heater is heated sufficiently to prevent freezing of piping within the system, which prevent possible damage to the piping. It should be understood that 33-43° F. or a value of 40° F. are examples for the value for the system that can be used but different values can be used instead and the controller programmed accordingly.

If the system does not detect a freeze protection condition, the controller programmed to determine the amount of power to supply to the heating elements (step 220). The algorithm used by the controller is a function of the difference between the desired or target temperature and the inlet water temperature measured at thermistor 135, the water flow rate measured by the flow transducer and a calibration factor, discussed below. The algorithm also includes a constant that is 147 W, which is the amount of power it takes to raise 1 gallon of water 1° F. in 1 minute. In FIG. 28, the constant is set at a value of 147 in step 220. Depending on the configuration of the system (different units that may be enabled), a different value may be set as the constant.

With the amount of power calculated (termed HeatW in FIG. 28) in step 220, the heating capacity of the heater is calculated in step 225. The heating capacity determined for the system is based on determining the voltage available to the heating system. For example, if the heater is being used along with an air conditioning unit and an electric dryer, the voltage available to the heater may be reduced, e.g., from 240 volts to 210 volts. In a traditional on-demand water heater, such a reduction in voltage would be expected to reduce the power output provided by the heating elements to the water. In one aspect of the on-demand water heater according to the invention, the heat percent (i.e., power output or duty cycle) is set as a function of the calculated power to be supplied with an increase based on the heating capacity. For example, if the voltage available is reduced, such as by simultaneous voltage draw from other appliances, to be 95 percent of the expected voltage (i.e., 220 or 240 volts) the HeatCapacity value would be 0.95 or an equivalent value. In this manner, the Heat % or duty cycle would be proportionally increased. This step according to one aspect of the invention is believed to ensure improved correspondence between the output water temperature and the desired water temperature. As a result, whether the voltage available to the heater is 200, 210, 220 or 240 volts, the system is designed to set the duty cycle such that the output water temperature is close to the desired water temperature.

With the Heat % value calculated in step 225, in one aspect of the invention, the controller is programmed with a look up table that is populated with a distribution of the power between the heating elements. Using the look up table, the order of powering of the heating elements is set along with their duty cycle. In one aspect of the invention, the look up table can be replaced with an algorithm to set the order of powering the heating elements and their duty cycle. The heat then is applied to the heating elements and the controller is programmed to proceed to the calibration update of step 230, disclosed in FIG. 29 and discussed below. After the calibration step, the controller is programmed to proceed to waiting for the next heater period (step 235) prior to passing through the process again. In the preferred embodiment, the heater period duration is 100 half cycles of the incoming AC waveform, which translates to 833 mS in a 60 Hz power system. This period was chosen from the combination of response time to flow and input temperature changes and duty cycle implementation simplicity. However, different heater period durations could be selected to adjust system responsiveness or other factors.

FIG. 29 illustrates the calibration process 240 for adjusting the heater operation based on factors including wear of the heating elements, replacement of heating elements, and use of heating of elements of different wattages. The calibration method 240 further corrects for discrepancies between the measured output temperature and the user-set target temperature, as well as diagnostic measurements of the system during use.

In step 245 the controller is programmed to determine how recently the system was calibrated. The calibration should not be performed too frequently, equivalent to a control system with a very long time constant. This ensures that the calibration factor is long term compensation adjusted relatively infrequently. If the calibration does not need to be performed, the controller is programmed to proceed to the end of the calibration process (step 247) without conducting any other operations. The controller proceeds through the heating cycle of process 200 disclosed in FIG. 28.

In step 250, the controller is programmed to determine if the flow measurement value provided by the flow transducer is constant or changing. If the flow is changing, the controller is programmed to proceed to the end of the calibration process (step 247) without conducting any other operations. Attempting to calibrate during changing flow could result in the calibration “chasing” the changing system.

If the flow is constant, the controller proceeds to determine if the output temperature is too high (step 255) or too low (step 260) compared to the target temperature based on the input parameters. If the output temperature is too high compared to the target (step 255), the controller is programmed to proceed to decrease the calibration factor (step 265). If the output temperature is not too high compared to the target, the controller is programmed to proceed to determine if the output temperature is too low compared to the target (step 260). If the output temperature is too low compared to the target (step 260), the controller is programmed to proceed to increase the calibration factor (step 270).

The controller is programmed to determine if the calibration factor calculated in step 265 is too low (step 280) or if the calibration factor calculated in step 270 is too high (step 275). If the calibration factor is either too low or too high, based on values set in the program, the controller is programmed to proceed to determine if the error has already been set (step 285), i.e., the calibration system has already determined there is a calibration error and an error code has been displayed on the control panel. If the error has already been set, the controller is programmed to proceed to the end of the calibration cycle (step 247) and return to the heating cycle.

If in step 285 the error has not been set already, the controller is programmed to proceed to step 290 and set the heater error and display that error on the control panel. The controller is next programmed to cycle through the heating elements to determine which one is creating the error condition (step 292). In this step the controller uses individual heating elements only and determines whether the power supplied to the individual heating element provides the expected output temperature. After cycling through the heating elements in this manner, the controller is able to pinpoint which heating element is not performing as expected. The controller then proceeds to finish the calibration cycle (step 247) and return to the heating cycle of process 200.

If in steps 275, 280, the calibration factor is neither too low nor too high, again, based on values set in the program, the controller is programmed to proceed to the next step (steps 294, 296) and clear any heater error that is displayed on the control panel. The controller then is programmed to proceed to finish the calibration cycle (step 247) and return to the heating cycle of process 200.

By adjusting the calibration factor, the system is able to adjust for changes due to wear in the individual heating elements, replacement of one or more heating elements and use of heating elements of different wattage, or any other factors that might contribute to error in output temperature.

What is claimed is:

1. A water heater comprising:
a cold water inlet;
a hot water outlet;
a fluid pathway arranged between the cold water inlet and the hot water outlet and adapted to convey water flowing from the cold water inlet to the hot water outlet;
one or more heating elements adapted to heat water that is in the fluid pathway;
a power electronics unit coupled to the one or more heating elements;
a controller configured to regulate a temperature of the water in the fluid pathway to an adjustable hot water temperature by controlling the power electronics unit;
a flow sensor to detect a water flow through the fluid pathway; and
an inlet water temperature sensor adapted to determine an inlet temperature of the water;
wherein the controller is configured to determine the power that is less than the maximum power that needs to be applied to the one or more heating elements and control the power electronics unit to modulate the power applied to the one or more heating elements so that the power is equally distributed across the one or more heating elements and whereby during any fixed period of time each of the heating elements is turned on for an equal amount of time.

2. The water heater of claim 1, wherein the controller is configured to control the power electronics unit to apply power to the one or more heating elements when the AC phase of the input power corresponds to 0 volts.

3. The water heater of claim 1, wherein the controller is configured to control the power electronics unit to apply power to the one or more heating elements when the AC phase of the input power corresponds to other than 0 volts.

4. The water heater of claim 1, wherein the power applied to the one or more heating elements is equally distributed over time, whereby large variations in current requirements are minimized.

5. The water heater of claim 1, wherein the water heater comprises two or more heating elements and applying power to the heating elements comprises sequentially applying power to each heating element.

6. The water heater of claim 1, wherein the water heater comprises two or more heating elements and applying power to the heating elements comprises sequentially applying the same average power to each heating element.

7. The water heater of claim 1, wherein the water heater comprises two or more heating elements and applying power to the heating elements comprises applying the same amount of power to each heating element with each heating element being powered on in a programmed sequence.

8. The water heater of claim 1, wherein the water heater comprises two or more heating elements and applying power to the heating elements comprises applying the same amount of power to each heating element with each heating element being powered on in a random sequence.

9. The water heater of claim 1, wherein the flow sensor to detect a water flow through the fluid pathway comprises an ultrasonic flow sensor.

10. The water heater of claim 1, wherein the controller is programmed to measure a voltage of the electricity provided to the water heater and modify the duty cycle applied to the heating elements based on the voltage of the electricity provided to the water heater.

11. The water heater of claim 1, wherein the water heater further comprises an outlet water temperature sensor adapted to determine an outlet temperature of the water and a calibration algorithm configured to modify the power applied to the one or more heating elements based on the difference between the water temperature measured at the outlet water temperature sensor and an expected water temperature expected to be measured at the outlet water temperature sensor.

12. The water heater of claim 11, wherein the calibration algorithm is further configured to analyze the amount of modification of the power applied to the one or more heating elements and if the amount of modification is more than a set amount, the calibration algorithm is configured to cycle between the one or more heating elements to determine which heating element requires the amount of modification of the power applied to be more than the set amount and provide an indication of the heating element.

13. The water heater of claim 1, wherein the controller is programmed to detect air in the fluid pathway and if air is detected in the fluid pathway, to apply no power to the heating elements.

14. The water heater of claim 1, wherein the controller is programmed to detect an inlet water temperature and apply an amount of power to the one or more heating elements sufficient to prevent freezing of a fluid in the fluid pathway if the temperature of the water measured is below a set value.

15. A water heater comprising:
a cold water inlet;
a hot water outlet;
a fluid pathway arranged between the cold water inlet and the hot water outlet and adapted to convey water flowing from the cold water inlet to the hot water outlet;
one or more heating elements adapted to heat water that is in the fluid pathway;
a power electronics unit coupled to the one or more heating elements;
a controller configured to regulate a temperature of the water in the fluid pathway to an adjustable hot water temperature by controlling the power electronics unit;
a flow sensor to detect a water flow through the fluid pathway; and
an inlet water temperature sensor adapted to determine an inlet temperature of the water,
wherein the flow sensor comprises an ultrasonic flow transducer to measure the rate of flow of water in the fluid pathway.

16. The water heater of claim 15, wherein the controller is configured to determine the power that is less than the maximum power that needs to be applied to the one or more heating elements and control the power electronics unit to modulate the power applied to the one or more heating elements so that the power is equally distributed across the one or more heating elements and whereby during any fixed period of time each of the heating elements is turned on for an equal amount of time.

17. A water heater comprising:
a cold water inlet;
a hot water outlet;
a fluid pathway arranged between the cold water inlet and the hot water outlet and adapted to convey water flowing from the cold water inlet to the hot water outlet;
one or more heating elements adapted to heat water that is in the fluid pathway;
a power electronics unit coupled to the one or more heating elements;
a controller configured to regulate a temperature of the water in the fluid pathway to an adjustable hot water temperature by controlling the power electronics unit;
a flow sensor to detect a water flow through the fluid pathway;
an inlet water temperature sensor adapted to determine an inlet temperature of the water; and
an outlet water temperature sensor adapted to determine an outlet temperature of the water,
wherein the controller is programmed with a calibration algorithm configured to modify the power applied to the one or more heating elements based on the difference between the water temperature measured at the outlet water temperature sensor and an expected water temperature expected to be measured at the outlet water temperature sensor.

18. The water heater of claim 17, wherein the calibration algorithm is further configured to analyze the amount of modification of the power applied to the one or more heating elements and if the amount of modification is more than a set amount, the calibration algorithm is configured to cycle between the one or more heating elements to determine which heating element requires the amount of modification of the power applied to be more than the set amount and provide an indication of the heating element.

19. The water heater of claim 17, wherein the flow sensor comprises an ultrasonic flow transducer to measure the rate of flow of water in the fluid pathway.

20. The water heater of claim 17, wherein the controller is configured to determine the power that is less than the maximum power that needs to be applied to the one or more heating elements and control the power electronics unit to modulate the power applied to the one or more heating elements so that the power is equally distributed across the one or more heating elements and whereby during any fixed period of time each of the heating elements is turned on for an equal amount of time.
